(19) United States
(12) Patent Application Publication
(10) Pub. No.: US 2007/0298190 A1
(43) Pub. Date: Dec. 27, 2007

(54) Method of Producing Metal Oxide Film

(76) Inventors: Hiroyuki Kobori, Tokyo (JP); Koujiro Ohkawa, Tokyo (JP); Keisuke Nomura, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/718,339

(22) PCT Filed: Nov. 10, 2005
(86) PCT No.: PCT/JP05/20644

§ 371 Date: May 1, 2007

(30) Foreign Application Priority Data
Nov. 10, 2004 (JP) 2004-326775

(51) Int. Cl. C01B 13/14; C23C 18/16

(52) U.S. Cl. 427/595; 427/443.1

(57) ABSTRACT

A method of producing a metal oxide film in which the metal oxide film is formed directly onto a surface of a substrate without subjecting the substrate surface to catalytic treatment, and the method which enables to make the obtained metal oxide film even through a simple process even if the substrate has a structural part. The metal oxide film is obtained by bringing a surface of a substrate into contact with a metal oxide film-forming solution that has a metal salt or a metal complex dissolved as a metal source, wherein the metal oxide film-forming solution comprises a reducing agent.

### TECHNICAL FIELD

The present invention relates to a method of producing a metal oxide film, in which a metal oxide film-forming solution containing a reducing agent is used.

### BACKGROUND ART

Conventionally, it has been known that metal oxide films exhibit various excellent physical properties. By making good use of this characteristic, the films are used in broad fields of transparent electroconductive films, optical thin films, electrolytes for fuel cells, and the like. Examples of a method of producing such a metal oxide film include a sol-gel method, sputtering, CVD, PVD, and printing. In any one of these methods, firing or a high-vacuum state is required. Thus, the machines required become large-sized to lead to problems such as the increase in costs and complex operability.

A different problem in the methods for producing a metal oxide film is that it is difficult to form an even metal oxide film onto a substrate that has a structural part. For example, in sputtering, the shape-following properties are poor because of its operation mechanism. In printing, it is difficult to form a film onto a structural part which is smaller than fine ceramic particles contained in ink. In CVD, which is relatively good in shape-following properties, advantageous effects are produced onto parts such as a shallow groove having a simple shape. However, it is difficult to form an even metal oxide film onto a complicated structural part.

Against such problems, suggested is a soft solution process of forming a metal oxide film directly from a solution onto a substrate (Non-Patent Document 1). Since neither firing nor any high-vacuum state is necessary in this soft solution process, the above-mentioned problems such as the grow in machine size can be solved. Furthermore, a substrate is brought into contact with a metal oxide film-forming solution; therefore, even if the substrate is a substrate having a complicated structural part, the solution can be caused to invade the inside of the structural part easily so that an even metal oxide film is obtained.

As an example of an attempt to use this soft solution process, Patent Document 1 discloses a method of causing a reaction solution which contains constituting elements of a thin film to be formed to flow, at a predetermined flow rate, between an anode electrode and a cathode electrode to which a predetermined voltage is applied, thereby forming a thin film. In Patent Document 1, the reaction solution contains an oxidizing agent but contains no reducing agent. Furthermore, the substrate is limited to electroconductive bodies and the granularity is rough in terms of the film quality of the resultant thin film.

Further for example, Patent Documents 2 and 3 each disclose a method of immersing a substrate subjected to catalytic treatment with an Ag catalyst or a Pd catalyst into a zinc oxide deposition solution so as to form a zinc oxide film by electroless deposition. According to these Patent Documents, a reducing agent such as dimethylamine borane is used, but the catalytic treatment of the substrate is an essential constituting element; thus, the method is not a method for forming a metal oxide film directly onto a surface of a substrate. Furthermore, in accordance with the usage of the metal oxide film, it is supposed that the metal used in the catalyst may not preferable in some cases. Moreover, there arises a problem that the process becomes complicated since the catalytic treatment is conducted.

Non-Patent Document 1: Journal of MMIJ (Shigen to Sozai) vol. 116, pp. 649-655 (2000)

Patent Document 1: Japanese Patent No. 3353070

Patent Document 2: Japanese Patent Application Laid-Open (JP-A) No. 2000-8180

Patent Document 3: JP-A No. 2000-336486

### DISCLOSURE OF THE INVENTION

### Problems to be Solved by the Invention

In light of the above-mentioned problems, the present invention has been made. A main object is to provide a method of producing a metal oxide film in which the metal oxide film is formed directly onto a surface of a substrate without subjecting the substrate surface to catalytic treatment, and the method which enables to make the obtained metal oxide film even through a simple process even if the substrate has a complicated structural part.

### Means for Solving the Problems

To solve the problems, the present invention provides a method of producing a metal oxide film, in which a metal oxide film is obtained by bringing a surface of a substrate into contact with a metal oxide film-forming solution that has a metal salt or a metal complex dissolved as a metal source, characterized in that the metal oxide film-forming solution comprises a reducing agent.

In the invention, an inclusion of a reducing agent into the above-mentioned metal oxide film-forming solution enables to form a metal oxide film directly onto a surface of a substrate without subjecting the substrate surface to catalytic treatment. Since the reducing agent generates electrons when decomposed, the electrolysis of water is induced so that the generated hydroxide ions make the pH of the solution high. As a result, an environment where the metal oxide film is easily formed is generated.

Moreover, the invention is a method of bringing the metal oxide film-forming solution into contact with the substrate, thereby yielding the metal oxide film directly from the solution; therefore, firing, high-vacuum, and other processes are not required and the process is simple, thereby making it possible to decrease costs. Furthermore, the invention has an advantage that: even if the substrate has a complicated structural part, the solution can easily invade the inside of the structural part; thus, the obtained metal oxide film becomes even.

In the present invention, an oxidized gas is preferably mixed at the time of bringing the metal oxide film-forming solution into contact with the surface of the substrate. Among the oxidized gas, oxygen or ozone is more preferably used to the others. By the mixing of the oxidized gas, the film-forming speed of the metal oxide film can be improved.

In the invention, it is preferred that at the time of bringing the metal oxide film-forming solution into contact with the surface of the substrate, ultraviolet rays are irradiated thereto. It appears that by the irradiation of the ultraviolet rays, a reaction corresponding to the electrolysis of water can be induced or the decomposition of the reducing agent can be promoted. Thus, the generated hydroxide ions make the pH of the metal oxide film-forming solution high so that an environment where the metal oxide film is easily formed can be generated. Furthermore, by the irradiation of the ultraviolet rays, the crystallinity of the resultant metal oxide film can be improved.

In the present invention, the metal source used in the metal oxide film-forming solution preferably comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta. The metal elements each have a metal oxide region or a metal hydroxide region in the Pourbaix diagram thereof; therefore, the elements are each suitable as a main constituting element of the metal oxide film.

In the present invention, the metal oxide film-forming solution preferably comprises at least one ion species selected from the group consisting of a chlorate ion, a perchlorate ion, a chlorite ion, a hypochlorite ion, a bromate ion, a hypobromate ion, a nitrate ion, and a nitrite ion.

The ions species each react with electrons, whereby hydroxide ions can be generated, to make the pH of the metal oxide film-forming solution high. As a result, an environment where the metal oxide film is easily formed can be generated.

### EFFECT OF THE INVENTION

The invention makes it possible to form a metal oxide film directly onto a substrate surface without subjecting the substrate surface to catalytic treatment; and produces an advantageous effect that even if the substrate has a complicated structural part, an even metal oxide film is yielded through a simple process.

### BEST MODE FOR CARRYING OUT THE INVENTION

Hereinafter, the method of the invention for producing a metal oxide film will be described in detail.

The method of producing a metal oxide film of the present invention, in which a metal oxide film is obtained by bringing a surface of a substrate into contact with a metal oxide film-forming solution that has a metal salt or a metal complex dissolved as a metal source, is characterized in that the metal oxide film-forming solution comprises a reducing agent. In the invention, the wording “a surface of a substrate or a substrate surface” means an outermost surface of a substrate, and does not mean a catalyst layer or other member obtained on a substrate by catalytic treatment or other process. In a porous substrate, the outermost surface of the substrate means not only the upper, the lower, and the sides of the porous substrate but also the inside thereof. When the metal oxide film-forming solution is brought into contact with the substrate surface to form a metal oxide film directly onto the substrate surface, the production process can be made simpler. In the invention, the “metal complex” includes, in the category, a substrate where an inorganic or organic material is coordinated to a metal ion, or the so-called organometallic compound, which has a metal-carbon bond in the molecule.

In the invention, for example, nonmetallic propoerties can be given to a metallic substrate subjected to microfabrication. Specifically, insulation properties can be given. The invention can be used at a higher temperature than any conventional insulating method using a resin. The metal oxide film produced by this method is excellent in adhesive properties to a metallic substrate, and is dense. Consequently, while in the conventional insulating method using a resin, a film thickness of about 10 μm is required, the present invention enables even a metal oxide film having a film thickness of about 1 μm to gain equivalent insulating properties.

In invention, for example, corrosion resistance can be given to a metallic substrate subjected to microfabrication. Specifically, when a metal oxide film that is strong in acid or alkali and has electroconductivity is formed, a member that can be used in an environment where a single use of metal cannot meet the purpose can be obtained. Furthermore, in the invention, a colored metal oxide film having corrosion resistance as described above can be obtained. Accordingly, the film can be used in a member for which designability is be desired, specifically a member for resisting acid rain in buildings or plants, or the like.

The invention can be used in a resin substrate subjected to microfabrication, or in other members. By use of the invention, it is possible to subject an inexpensive resin, which is easily worked for microfabrication, and to provide organic solvent resistance, hydrophilicity or living body affinity thereto. Accordingly, the invention can be used in organic solvent plants, organic solvent containers, biochips, or all physical and chemical appliances.

Moreover, the invention makes it possible to yield a metal oxide film at a lower temperature than any conventional method of producing a metal oxide film. Accordingly, a heat non-resistant substrate such as resins or papers can be used. Thus, the invention can exhibit broad range of applicability to, for example, the field of ever-downsizing electronic devices, of energy-related devices which have been made integrated with each other, and of diversified biotechnology.

The mechanism of the method of the invention for producing a metal oxide film will be described, by referring a case of using cerium nitrate (Ce (NO₃) 3) as a metal source and using a borane-dimethylamine complex (alias: dimethylamineborane, DMAB) to form a cerium oxide (CeO₂) film.

Although the mechanism is not made completely clear, it appears that the cerium oxide is formed in accordance with the following six formulae:
Ce(NO₃)₃→Ce³⁺+3NO₃⁻ (i)
(CH₃)₂NHBH₃+2H₂O→BO₂⁻+(CH₃)₂NH+7H⁺+6e⁻ (ii)
2H₂O+2e⁻→2OH⁻+H₂ (iii)
Ce³⁺→Ce⁴⁺e⁻ (iv)
Ce⁴⁺+2OH⁻→Ce(OH)₂²⁺ (v)
Ce(OH)₂²⁺→CeO₂+H₂ (vi)

This mechanism will be specifically described, using the drawings. As illustrated in FIG. 1A, cerium nitrate and DMAB are first dissolved into water as a solvent to prepare a metal oxide film-forming solution 1. A substrate 2 is immersed into this solution. At this time, cerium nitrate turns to cerium ions (formula (i)). Subsequently, as illustrated in FIG. 1B, the reducing agent DMAB decomposes (formula (ii)) to release electrons. Thereafter, as illustrated in FIG. 1C, the released electrons induce the electrolysis of water (formula (iii)) to generate hydroxide ions, thereby making the pH of the metal oxide film-forming solution high. As a result, the valence of the cerium ions is changed (formula (iv)), and the cerium ions react with the generated hydroxide ions (formula (v)), so that Ce(OH)₂²⁺ is generated, as illustrated in FIG. 1D. Thereafter, as illustrated in FIG. 1E, Ce(OH)₂²⁺ near the substrate 2 turns to CeO₂ by the local rise in the pH (formula (vi)). The reactions (ii) to (vi) are repeated, thereby forming a cerium oxide film 3, as illustrated in FIG. 1F.

FIG. 2 shows the Pourbaix diagram of cerium. It can be considered that the above-mentioned reactions are a process where Ce³⁺ generated in the formula (i) enters a region of CeO₂ by the rise in the pH based on the hydroxide ions generated in the formula (iii). From this matter, a metal element having a similar metal oxide region would also be able to give a metal oxide film by the production method of the invention. Even a metal element having a metal hydroxide region can give a metal oxide film by heating a metal hydroxide film thereof. At the time of using not water but such as an alcohol or an organic solvent as a solvent in the invention, a metal oxide film would be generated by a reaction similar to the above-mentioned reaction or by a very small amount of water contained in the solvent.

About the method of the invention for producing a metal oxide film, each of constituting elements thereof will be described in detail hereinafter.

1. Metal Oxide Film-Forming Solution

First, the metal oxide film-forming solution used in the method of the invention for producing a metal oxide film is described. The metal oxide film-forming solution used in the invention is a solution containing at least a reducing agent, a metal salt or metal complex as a metal source, and a solvent.

(1) Reducing Agent

The reducing agent used in the invention is an agent having a function of releasing electrons by the decomposition reaction and generating hydroxide ions by the decomposition reaction of water, thereby making the pH of the metal oxide film-forming solution high. The pH is made high to lead the system into the metal oxide region or the metal hydroxide region in the Pourbaix diagram, thereby producing an environment where a metal oxide film is easily generated.

The concentration of the reducing agent in the metal oxide film-forming solution used in the invention is varied in accordance with the kind of the reducing agent, and is usually from 0.001 to 1 mol/L, in particular preferably from 0.01 to 0.1 mol/L. If the concentration is below the range, a reaction for forming a metal oxide film is not easily caused so that a sufficient film-forming speed may not be obtained. If the concentration is over the range, obtained advantageous effects do not have a large difference. Thus, such a case is not favorable from the viewpoint of costs.

This reducing agent is not particularly limited as long as the agent is dissolved in a solvent detailed later and can release electrons by the decomposition reaction. Examples include boron based complexes such as a boron-tert-butylamine complex, a boron-N,N diethylaniline complex, a bron-dimethylamine complex and a boron-trimethylamine complex, sodium cyanoborohydride, and sodium borohydride. It is particularly preferred to use a boron based complex.

(2) Metal Source

The metal source used in the invention is a source that is dissolved in the metal oxide film-forming solution to provide a metal oxide film by action of the reducing agent and the like. The metal source used in the invention may be a metal salt or a metal complex as long as the source is dissolved in the solvent that will be detailed later.

The concentration of the metal source in the metal oxide film-forming solution used in the invention is as follows: when the metal source is a metal salt, it is usually from 0.001 to 1 mol/L, in particular preferably from 0.01 to 0.1 mol/L; and when the metal source is a metal complex, it is usually from 0.001 to 1 mol/L, in particular preferably from 0.01 to 0.1 mol/L. If the concentration is below the range, a reaction for forming a metal oxide film is not easily caused so that a desired metal oxide film may not be obtained. If the concentration is over the range, the metal source may turn to a precipitation.

The metal element which constitutes this metal source is not particularly limited as long as the element can give a desired metal oxide film. The metal element is preferably selected form the group consisting of, for example, Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta. The metal elements each have a metal oxide region or a metal hydroxide region in the Pourbaix diagram thereof; therefore, the elements are each suitable as a main constituting element of a metal oxide film.

Specific examples of the above-mentioned metal salt include chlorides, nitrates, sulfates, perchlorates, acetates, phosphates, and bromates which each contain the above-mentioned metal element. In the invention, it is particularly preferred to use such as a chloride, a nitrate, or an acetate since these compounds are easily available as widely-used products.

Specific examples of the above-mentioned metal complex include magnesium diethoxide, aluminum acetylacetonate, calcium acetylacetonate dihydrate, calcium di(methoxyethoxide), calcium gluconate monohydrate, calcium citrate tetrahydrate, calcium salicylate dihydrate, titanium lactate, titanium acetylacetonate, tetraisopropyl titanate, tetra-n-butyl titanate, tetra(2-ethylhexyl) titanate, butyl titanate dimer, titanium bis(ethylhexoxy)bis(2-ethyl-3-hydroxyhexoxide), diiopropoxytitanium bis(triethanolaminate), dihydroxybis(ammonium lactate) titanium, diisopropoxytitanium bis(ethylacetoacetate), titaniumperoxicitricacid ammonium tetrahydrate, dicyclopentadienyl iron (II), iron (II) lactate trihydrate, iron (III) acetylacetonate, cobalt (II) acetylacetonate, nickel (II) acetylacetonate dihydrate, copper (II) acetylacetonate, copper (II) dipyvaloylmethanate, copper (II) ethylacetoacetate, zinc acetylacetonate, zinc lactate trihydrate, zinc salicylate trihydrate, zinc stearate, strontium dipyvarolylmethanate, yttrium dipyvaroyl methanate, zirconium tetra-n-butoxide, zirconium (IV) ethoxide, zirconium n-propinate, zirconium n-butyrate, zirconium tetraacetylacetonate, zirconium monoacetylacetonate, zirconium acetylacetonate bisethylacetoacetate, zirconium acetate, zirconium monostearate, penta-n-butoxyniobium, pentaethoxyniobium, pentaisopropoxyniobium, indium (III) tris(acetylacetonate), indium (III) 2-ethylhexanoate, tetraethyltin, oxydibutyltin (IV), tricyclohexyltin (IV) hydroxide, lanthanum acetylacetonate dihydrate, tri(methoxyethoxy)lanthanum, pentaisopropoxytantalum, pentaethoxytantalum, tantalum (V) ethoxide, cerium (III) acetylacetonate n-hydrate, lead (III) citrate trihydrate, and lead cyclohexanebutyrate. In the invention, it is preferred to use magnesium diethoxide, aluminum acetylacetonate, calcium acetylacetonate dihydrate, titanium lactate, titanium acetylacetonate, tetraisopropyl titanate, tetra-n-butyl titanate, tetra(2-ethylhexyl) titanate, butyl titanate dimer, diisopropoxytitanium bis(ethylacetoacetate), iron (II) lactate trihydrate, iron (III) acetylacetonate, zinc acetylacetonate, zinc lactate trihydrate, strontium dipyvarolylmethanate, pentaethoxyniobium, indium (III) tris(acetylacetonate), indium (III) 2-ethylhexanoate, tetraethyltin, oxydibutyltin (IV), lanthanum acetylacetonate dihydrate, tri(methoxyethoxy) lanthanum, and cerium (III) acetylacetonate n-hydrate.

In the invention, the metal oxide film-forming solution may contain two or more of the above-mentioned metal elements. The use of two or more of the metal elements makes it possible to yield a complex metal oxide film made of, for example, ITO, Gd—CeO₂, Sm—CeO₂, or Ni—Fe₂O₃.

(3) Solvent

The solvent used in the invention is not particularly limited as long as the reducing agent, the metal source mentioned-above can be dissolved therein. When the metal source is a metal salt, examples thereof include water; lower alcohols where the total number of carbon atoms is 5 or less, such as methanol, ethanol, isopropyl alcohol, propanol or butanol; toluene; and mixed solvents thereof. When the metal source is a metal complex, examples thereof include water, the above-mentioned lower alcohols, toluene, and mixed solvents thereof. In the invention, the above-mentioned solvents may be combined for use. In the case of using, for example, a metal complex that has a low solubility in water and a high solubility in an organic solvent and a reducing agent that has a low solubility in the organic solvent and a high solubility in water, water is mixed with the organic solvent, thereby dissolving the two in each other. In this way, an even metal oxide film-forming solution can be prepared.

(4) Additives

The metal oxide film-forming solution used in the invention may contain additives such as an auxiliary ion source, and a surfactant.

The auxiliary ion source is a source which reacts with electrons to generate hydroxyl ions. The source makes it possible to make the pH of the metal oxide film-forming solution high, thereby generating an environment where a metal oxide film is easily formed. It is preferred to select the use amount of the auxiliary ion source appropriately in accordance with the used metal source and reducing agent.

A specific example of the auxiliary ion source is an ion species selected from the group consisting of a chlorate ion, a perchlorate ion, a chlorite ion, a hypochlorite ion, bromate ion, a hypobromate ion, a nitrate ion, and a nitrite ion. These auxiliary ion sources would cause the following reactions in the solution:
ClO₄⁻+H₂O+2e⁻ [symbol] ClO₃⁻+2OH⁻
ClO₃⁻+H₂O+2e⁻ [symbol] ClO₂⁻+2OH⁻
ClO₂⁻+H₂O+2e⁻ [symbol] ClO⁻+2OH⁻
2ClO⁻+2H₂O+2e⁻ [symbol] Cl₂(g)+4OH⁻
BrO₃⁻+2H₂O+4e⁻ [symbol] BrO⁻+4OH⁻
2BrO⁻+2H₂O+2e⁻ [symbol] Br₂+4OH⁻
NO₃⁻+H₂O+2e⁻ [symbol] NO₂⁻+2OH⁻
NO₂⁻+3H₂O+3e⁻ [symbol] NH₃+3OH⁻

The above-mentioned surfactant is an agent having a function of acting onto the interface between the metal oxide film-forming solution and the substrate surface to make the generation of a metal oxide film on the substrate surface easy. It is preferred to select the use amount of the surfactant appropriately in accordance with the used metal source and reducing agent.

Examples of the surfactant include SURFYNOL series, such as SURFYNOL 485, SURFYNOL SE, SURFYNOL SE-F, SURFYNOL 504, SURFYNOL GA, SURFYNOL 104A, SURFYNOL 104BC, SURFYNOL 104PPM, SURFYNOL 104E, and SURFYNOL 104PA, which are each manufactured by Nissin Chemical Industry Co., Ltd.; and NIKKOL AM301, and NIKKOL AM313ON, which are each manufactured by Nikko Chemicals Co., Ltd.

2. Substrate

Next, the substrate used in the method of the invention for producing a metal oxide film is described. The material of the substrate used in the invention is not particularly limited, and the following can be used for example: a glass, a plastic, a resin, a metal, an alloy, a semiconductor, a ceramic, a paper, or a fabric. It is preferred to select the material of the substrate appropriately, considering functions given by the metal oxide film, such as corrosion resistance, insulation properties, hydrophilicity, and the usage of the member.

The substrate used in the invention is not particularly limited, and may be, for example, an object having a flat and smooth surface, an object having a microscopic structural part, an object in which a hole is made, an object in which a groove is made, an object in which a flow channel is present, a porous object, or an object having a porous film. In the invention, particularly preferred is a substrate having a microscopic structure, a porous substrate, or a substrate having a porous film since the metal oxide film-forming solution can invade the inside of the substrate to produce a metal oxide film having good shape-following properties.

3. Manner of Bringing the Substrate and the Metal Oxide Film-Forming Solution into Contact with Each Other

Next, the manner of bringing the substrate and the metal oxide film-forming solution into contact with each other is described. The contacting manner in the invention is not particularly limited as long as the above-mentioned substrate and metal oxide film-forming solution can be caused to contact each other. Specific examples of the manner include a roll coating manner, a dipping manner, a sheet-forming manner, and a manner of coating the solution made into a mist form.

The roll coating manner is a manner as illustrated in, for example, FIG. 3, where a substrate 2 is caused to pass between a roll 4 and a roll 5 to form a metal oxide film onto a substrate surface, and is suitable for continuously producing metal oxide film. The dipping manner is a method of immersing the substrate into the metal oxide film-forming solution, thereby forming metal oxide films onto surfaces of the substrate. As illustrated in, for example, FIG. 4A, the whole of a substrate 2 is immersed into a metal oxide film-forming solution 1, thereby forming metal oxide films onto the whole surfaces of the substrate 2. When shielding portions are formed on the surfaces of the substrate 2, patterned metal oxide films can be formed on the surfaces of the substrate 2, which is not illustrated in FIG. 4A. As illustrated in, for example, FIG. 4B, the metal oxide film-forming solution 1 is caused to flow at a constant flow rate so as to be brought into contact with only the inner face of the substrate 2, thereby making it possible to form a metal oxide film onto the inner face only. The sheet-forming manner is a manner as illustrated in, for example, FIG. 5, where a metal oxide film-forming solution 1 is circulated by means of a pump 6 to heat only a substrate 2, thereby promoting decomposition reaction of the reducing agent near a surface of the substrate to form a metal oxide film on the substrate surface.

In the method of the invention for producing a metal oxide film, at the time of bringing the surface of the substrate into contact with the metal oxide film-forming solution, an oxidized gas is mixed therewith, ultraviolet rays are irradiated thereon, the two are heated, or these manners are combined with each other, whereby the film-forming speed of the metal oxide film can be improved. These manners will be described hereinafter.

(1) Improvement on the Film-Forming Speed by the Mixing of an Oxidized Gas

In the invention, it is preferred that at the time of bringing the substrate surface and the metal oxide film-forming solution into contact with each other, an oxidized gas is mixed therewith.

This oxidized gas is not particularly limited as long as the gas is a gas having oxidizing capability and making it possible to improve the film-forming speed of the metal oxide film. Examples thereof include oxygen, ozone, nitrogen peroxide, nitrogen dioxide, chlorine dioxide, and halogen gases. It is preferred to use oxygen and ozone out of these gases, and particularly preferred to use ozone since ozone is industrially widely available so that costs can be reduced.

The manner of mixing the oxidized gas is not particularly limited. When using the above-mentioned immersing manner for example the manner is a manner of bringing the above-mentioned oxidized gas in an air bubble form into contact with the contact region of the substrate surface and the metal oxide film-forming solution. The introduction of the air-bubble form oxidized gas is not particularly limited, and, a manner of using a bubbler can be cited as an example. The use of the bubbler makes it possible to increase the contact area between the oxidized gas and the solution to effectively improve the film-forming speed of the metal oxide film. As this bubbler, ordinary bubblers can be used, and a Naflon Bubbler [transliteration] (manufactured by AS ONE CORPORATION) can be cited as an example. Usually, the oxidized gas can be supplied from a gas cylinder. Regarding ozone, it can be supplied from an ozone generating device to the metal oxide film-forming solution.

(2) Improvement on the Film Forming Speed by the Irradiation of Ultraviolet Rays

In the invention, it is also preferred that at the time of bringing the substrate surface and the metal oxide film-forming solution into contact with each other, ultraviolet rays are irradiated thereto. The irradiation of the ultraviolet rays would make it possible to induce a reaction corresponding to the electrolysis of water or promote the decomposition of the reducing agent. As a result, the generated hydroxide ions cause a rise in the pH of the metal oxide film-forming solution so that an environment where a metal oxide film is easily formed can be generated. Moreover, the irradiation of the ultraviolet rays makes it possible to generate hydroxide ions from the auxiliary ion source, and further improve the crystallinity of the resultant metal oxide film.

The manner of irradiating the ultraviolet rays in the preset embodiment is not particularly limited as long as it is a manner of irradiating ultraviolet rays to the contact region of the substrate surface and the metal oxide film-forming solution. In the case of using, for example, the above-mentioned immersing manner, the manner is a manner as illustrated in FIG. 6, in which a substrate 2 is immersed into a metal oxide film-forming solution 1, and ultraviolet rays 7 are irradiated thereto from the side of the solution. In this case, the thickness of the metal oxide film-forming solution, present on the substrate surface onto which the ultraviolet rays are irradiated, is preferably thin so that the ultraviolet rays can be irradiated precisely onto the contact region of the substrate surface and the metal oxide film-forming solution.

The wavelength of ultraviolet rays used in the embodiment is usually from 185 to 470 nm, in particular preferably from 185 to 260 nm. The intensity of the ultraviolet rays used in the embodiment is usually from 1 to 20 mW/cm², in particular preferably from 5 to 15 mW/cm².

As an ultraviolet ray radiating device for conducting the ultraviolet ray irradiation, there can be used a UV light irradiating device, a laser emitting device or the like that is commercially available. An example thereof is an HB400X-21 manufactured by SEN LIGHTS CORPORATIONORATION.

(3) Improvement on the Film-Forming Speed by Heating

In the invention, it is also preferred that at the time of bringing the substrate surface and the metal oxide film-forming solution into contact with each other, they are heated. The heating makes it possible to promote the decomposition reaction of the reducing agent to improve the film-forming speed. The manner for the heating is not particularly limited as long as the manner can cause an improvement in the film-forming speed of the metal oxide film. It is preferred to heat the substrate, and it is particularly preferred to heat the substrate and the metal oxide film-forming solution since the decomposition reaction of the reducing agent can be promoted near the substrate.

Preferably, the temperature for the heating is appropriately selected in accordance with features of the used reducing agent and substrate. Specifically, the temperature ranges preferably from 50 to 150° C., more preferably from 70 to 100° C.

4. Metal Oxide Film

Next, the metal oxide film obtained by the metal oxide film producing method of the invention is described. The metal oxide film producing method of the invention is wet coating using a metal oxide film-forming solution. Thus, in the case of, for example, a porous substrate or a substrate having a porous body, the metal oxide film-forming solution can easily invade the inside of the porous body or the like so that an even metal oxide film can be obtained.

The metal oxide film obtained by the metal oxide film producing method of the invention can be regarded as an underlying layer for a porous substrate or a substrate having a porous body, on which a dense metal oxide film is not ordinarily obtained with ease. The metal oxide formed as this underlying layer constitutes crystal nuclei, and an optional metal oxide film producing manner is used to cause the crystal nuclei to grow. In this way, a dense metal oxide film having a sufficient film thickness can be formed on the porous body or the like. The manner that can be used to cause the crystal nuclei to grow may be an ordinary metal oxide film producing manner, and examples thereof include PVD manners such as a vacuum evaporation manner, a sputtering manner, an ion plating manner, and CVD manners such as a plasma CVD, a thermal CVD and an atmospheric pressure CVD.

In the case of combining such metal oxide film producing manners with each other to yield a metal oxide film having a desired denseness and film thickness, the metal oxide film obtained by the metal oxide film producing method of the invention may be a metal oxide film which completely covers the substrate surface. Alternatively, the metal oxide film may partially cover the substrate. Examples of the metal oxide film which partially covers the substrate include a case where a metal oxide film is present in a sea-island form inside a porous substrate, and a case where a metal oxide film is present in a pattern form on a smooth substrate surface.

5. Others

In the metal oxide film producing method of the invention, the metal oxide film obtained in the above-mentioned contacting manner or the like may be washed and dried.

The washing of the metal oxide film is performed to remove impurities present on the surface and the like of the metal oxide film. An example is a wash using the solvent used in the metal oxide film-forming solution.

The drying of the metal oxide film may be performed by allowing the film to stand still at room temperature, or may be performed in a device such as an oven.

The invention is not limited to the above-mentioned embodiments. The embodiments are illustrative, and all that has substantially the same structure and produce the same effect and advantages as the technical conception recited in the claims of the invention are included in the technical scope of the invention.

### EXAMPLES

The invention will be specifically described by way of the following examples.

### Example 1

### Formation of an ITO Film on a Porous Alumina Particle Layer

A 20 wt % solution of alumina fine particles (manufactured by Micron Co., Ltd., particle diameter: 30 μm) was coated onto a glass substrate by a bar coating manner, and the resultant was fired at a temperature of 500° C. for 2 hours to yield the glass substrate on which a porous alumina particle layer was formed.

Next, a boron-trimethylamine complex (manufactured by KANTO KAGAKU) as a reducing agent was added to 1000 g of a 0.03 mol/L indium chloride and 0.001 mol/L tin chloride solution in water so as to give a concentration of 0.1 mol/L. Furthermore, 2 g of sodium chlorinate was added as an auxiliary ion source to the solution to yield a metal oxide film-forming solution.

Next, the substrate obtained by the above-mentioned method was immersed in the above-mentioned solution at a temperature of 70° C. for 12 hours. At this time, the metal oxide film-forming solution was circulated and caused to pass through a filter to remove a precipitation and mixed dusts. As a result, a metal oxide film was yielded on the substrate. Thereafter, the resultant was washed with pure water, dried at 100° C. for 1 hour, and further fired at 350° C. for 1 hour.

An X-ray diffraction meter (RINT-1500, manufactured by Rigaku Corporation) was used to measure the metal oxide film obtained by the above-mentioned method. As a result, it was verified that an ITO film was formed. Moreover, an electron beam microanalyzer (JXA-8900R, manufactured by JEOL Ltd.) was used to measure the ITO film. As a result, it was verified that ITO reached not only the surface of the porous alumina particle layer but also the inside (the glass substrate contact region) thereof. It was also verified that the porous alumina particle layer was completely covered with the ITO film.

### Comparative Example 1

### Formation of a Silicon Oxide Film on a Porous Alumina Particle Layer by CVD

The glass substrate on which the porous alumina particle layer was formed, which was used in Example 1, was used to yield a metal oxide film on the porous alumina particle layer by use of a CVD. Conditions for the CVD were as follows: the applied voltage was 1.0 kW, the film forming pressure was 40 Pa, the flow rate of hexamethyldisilazane was 40 sccm, the flow rate of oxygen gas was 0.5 slm, and the temperature of the substrate surface on which the film was to be formed (the film forming temperature) was 30° C.

The above-mentioned X-ray diffraction meter was used to measure the metal oxide film obtained by the above-mentioned method. As a result, it was verified that a silicon oxide film was formed. However, a measurement of the silicon oxide film by use of the above-mentioned electron microanalyzer demonstrated that silicon oxide was present on the surface of the porous alumina particle layer surface while no silicon oxide was present inside the porous alumina particle layer so that a sufficient shape-following property was not exhibited. The porous alumina particle layer was not completely covered with the silicon oxide film.

### Example 2

### Formation of a Zirconium Oxide Film on a Copper Substrate Subjected to Microfabrication

In the present example, a zirconium oxide film was formed on a copper substrate subjected to a microfabrication, and the corrosion resistance thereof was evaluated.

In the example, a copper (thickness: 0.5 mm) subjected to a microfabrication (holes 1 mm in diameter and 50 μm in depth, and grooves 50 μm in width, 10 mm in length, and 20 μm in depth) by an etching method was firstly prepared as a substrate.

Next, a boron-dimethylamine complex (model number: 04886-35, manufactured by KANTO KAGAKU) as a reducing agent was added to 1000 g of a 0.03 mol/L oxyzirconium nitrate solution in water to give a concentration of 0.1 mol/L, so as to yield a metal oxide film-forming solution.

Next, the metal oxide film-forming solution was heated up to a temperature of 70° C., and a Naflon Bubbler (manufactured by AS ONE CORPORATION) was used to generate air bubbles at a constant temperature of 70° C. At this time, the metal oxide film-forming solution was circulated and caused to pass through a filter to remove a precipitation and mixed dusts. The substrate was subjected to ultrasonic washing with a neutral detergent, and immersed into the solution for 1 hour to yield a metal oxide film on the substrate. Thereafter, the resultant was washed with pure water, dried at 80° C. for 1 hour, and fired at 500° C. for 1 hour.

The metal oxide film yielded by the above-mentioned method was observed by the naked eye. As a result, a film corresponding to a degree that interference color was observed was found in each of both faces of the substrate and the microfabricated region thereof. The metal oxide films were each measured by the above-mentioned X-ray diffraction meter. As a result, it was proved that the films were each an amorphous film. Thus, the composition of each of the films was analyzed by a photoelectron spectral analyzer (ESCALAB 200i-XL, manufactured by V. C. Scientific Ltd.). As a result, the amount of Zr was 30.2 atomic %, and the amount of oxygen was 64.5 atomic %, and it was able to be verified that a zirconium oxide film was formed.

### Comparative Example 2

### Formation of a Zirconium Oxide Film on a Copper Substrate Subjected to Microfabrication by Dip Coating

In the present comparative example, the copper (thickness: 0.5 mm) subjected to a microfabrication (holes 1 mm in diameter and 50 μm in depth, and grooves 50 μm in width, 10 mm in length, and 20 μm in depth) used in Example 2 was used as a substrate.

Next, a 10% solution of zirconium oxide fine particles (manufactured by Hosokawa Micron Group) in ethanol was prepared, and coated onto the substrate by dipping. The resultant was fired at 500° C. in an electric muffle furnace (P90, manufactured by DENKEN CO, LTD.) for 2 hours to yield a zirconium oxide film on the substrate.

The zirconium oxide film yielded by the above-mentioned method was immersed in a solution of iodine (Wako Pure Chemical Industries, Ltd.) for 24 hours. As a result, pore corrosion was found out in the same manner as in the substrate which had not been subjected to any treatment. Thus, a sufficient corrosion resistance was not exhibited.

### Example 3

### Formation of a Titanium Oxide Film onto an Acrylic Substrate Subjected to Microfabrication

An object of the present example was to form a titanium oxide film onto an acrylic substrate that is subjected to a microfabrication, thereby giving hydrophilicity thereto.

In the example, an acrylic substrate (thickness: 5 μm) subjected to mechanical microfabrication (grooves 500 μm in width, 100 mm in length, and 50 μm in depth) was first prepared as a substrate.

Next, diisopropoxytitanium bis(ethylacetate) (manufactured by Matsumoto Chemical Industry Co., Ltd.) was dissolved into 1000 g of a mixed solution where water, isopropyl alcohol (IPA), and toluene were adjusted to give a ratio of 4:4:1, so as to give a concentration of 0.1 mol/L. Next, a boron-dimethyl sulfide complex (manufactured by KANTO KAGAKU), as a reducing agent, was added to the solution so as to give a concentration of 0.1 mol/L. Furthermore, 1 g of sodium nitrite was added to the solution to yield a metal oxide film-forming solution.

Next, the above-mentioned substrate was kept at 80° C., and the Naflon bubbler (manufactured by AS ONE CORPORATION) was used in the metal oxide film-forming solution to generate air bubbles at a constant temperature of 80° C., thereby supplying the air bubbles to the substrate. At this time, the metal oxide film-forming solution was circulated and caused to pass through a filter to remove a precipitation and mixed dusts. Furthermore, the ultraviolet radiating device (HB400X-21, manufactured by SEN LIGHTS CORPORATION) was used to irradiate ultraviolet rays onto the substrate at an intensity of 80 mW/cm², thereby yielding a metal oxide film onto the substrate. Thereafter, the resultant was washed with pure water, and dried at 100° C. for 1 hour.

The X-ray diffraction device was used to measure the metal oxide film. As a result, it was able to be verified that a titanium oxide film was formed. The contact angle of the titanium oxide film with water was measured. It was 25°. It was verified that the film had hydrophilicity. The contact angle of the titanium oxide film with water was a value obtained from a result of a measurement thereof (after 30 seconds from a time when liquid droplets were dropped from a micro-syringe) with a contact angle measuring instrument (CA-Z model, manufactured by Kyowa Interface Science Co., Ltd.).

### Example 4

In the present example, a SUS was used as a substrate, and a zirconium oxide film was formed on the SUS. First, oxyzirconium chloride 8-hydrate (ZrCl₂O.8H₂O) was dissolved, as a metal source, into a mixed solvent made of 80 vol % of water and 20 vol % of isopropyl alcohol (IPA) to prepare a solution having a concentration of 0.06 mol/L in an amount of 1000 g. Thereafter, a boron-dimethyl amine (manufactured by KANTO KAGAKU), as a reducing agent, was added to the solution so as to give a concentration of 0.08 mol/L.

Next, the above-mentioned substrate was immersed into the metal oxide film-forming solution while the temperature of the solution was kept at a constant temperature of 50° C. The Naflon bubbler (manufactured by AS ONE CORPORATION) was used to generate air bubbles, thereby supplying the air bubbles to the substrate. At this time, the metal oxide film-forming solution was circulated and caused to pass through a filter to remove a precipitation and mixed dusts. Furthermore, the above-mentioned ultraviolet radiating device was used to irradiate ultraviolet rays onto the substrate at an intensity of 20 mW/cm², thereby yielding a metal oxide film onto the substrate. Thereafter, the resultant was washed with pure water, and dried at 100° C. for 1 hour.

The X-ray diffraction device was used to measure the metal oxide film. As a result, it was able to be verified that a zirconium oxide film was formed. The metal oxide film was analyzed by the photoelectron spectral analyzer (ESCALAB 200i-XL, manufactured by V. G. Scientific Ltd.). As a result, it was able to be confirmed that the zirconium oxide film was formed. A scanning electron microscope (SEM) was used to measure the film thickness of the metal oxide film. As a result, it was 200 nm.

### Examples 5 to 37

In Examples 5 to 37, under experiment conditions shown in Tables 1 and 2, metal oxide films were each formed on a substrate. The method for forming each of the metal oxide films and the method for measuring physical properties thereof were according to those in Example 4.

The glass/TiO₂ substrate was a product where TiO₂ fine particles were coated into a paste form onto a glass. The production method thereof is specifically as follows. First, added to water and isopropyl alcohol as solvents were titanium oxide fine particles having a primary particle diameter of 20 nm (P25, manufactured by Nippon Aerosil Co., Ltd.), acetylacetone, and polyethylene glycol (average molecular weight: 3000) to give concentrations of 37.5% by weight, 1.25% by weight, and 1.88% by weight, respectively. A homogenizer was used to produce a slurry where the above-mentioned sample was dissolved or dispersed. This slurry was coated on a glass substrate by a doctor blade method, and the resultant was allowed to stand still for 20 minutes and dried at 100° C. for 30 minutes. Subsequently, an electric muffle furnace (P90, manufactured by DENKEN CO, LTD.) was used to fire the substrate with the dried film at 500° C. under an atmospheric pressure for 30 minutes. In this way, the porous-titanium-oxide-film-attached glass substrate (glass/TiO₂ substrate) was yielded.

The production method of the glass/ZrO₂ substrate is as follows. First, added to water and isopropyl alcohol as solvents were zirconium oxide fine particles (manufactured by Hosokawa Micron Group) having a BET conversed diameter of 37 nm, ethanol, and polyethylene glycol (average molecular weight: 3000) to give concentrations of 40% by weight, 1.5% by weight, and 1.88% by weight, respectively. A homogenizer was used to produce a slurry where the above-mentioned sample was dissolved or dispersed. This slurry was coated on a glass substrate by a doctor blade method, and the resultant was allowed to stand still for 20 minutes and dried at 100° C. for 15 minutes. Subsequently, the electric muffle furnace (P90, manufactured by DENKEN CO, LTD.) was used to fire the substrate with the dried film at 500° C. under an atmospheric pressure for 60 minutes. In this way, the porous-zirconium-oxide-film-attached glass substrate (glass/ZrO₂ substrate) was yielded.

In Examples 9 and 11, where a metal complex was used as the metal source, a mixed solvent made of 70 vol % of water, 20 vol % of isopropyl alcohol, and 10 vol % of toluene was used as the solvent. In Example 10, where a metal complex was used as the metal source in the same manner, a mixed solvent made of 10 vol % of water, 70 vol % of isopropyl alcohol, and 20 vol % of toluene was used as the solvent. In Example 12, a mixed solvent made of 70 vol % of isopropyl alcohol and 30 vol % of toluene was used as the solvent.

In the examples other than the above-mentioned examples, out of Examples 4 to 37, a mixed solvent made of 80 vol % of water and 20 vol % of isopropyl alcohol was used respectively.

In each of Examples 6, 7, 13, 31, 32, 35 and 36, it was able to be verified by the photoelectron spectral analyzer (ESCALAB 200i-XL, manufactured by V. G. Scientific Ltd.) that a metal oxide film was formed.

Experiment conditions and results in Examples 4 to 37 are shown in Tables 1 and 2.

TABLE 1

| | Metal | | | Reducing | | Auxiliary | | | Liquid |
|---|---|---|---|---|---|---|---|---|---|
| | oxide | | | agent | | ion source | | | temperature |
| | film | Metal Source (mol/l) | | (mol/l) | | (mol/l) | | Substrate | (° C.) |
| Example 4 | ZrO₂ | ZrCl₂O∵8H₂O | 0.06 | \textcircled{3} | 0.08 | — | — | SUS | 50 |
| Example 5 | SnO₂ | SnCl₂∵2H₂O | 0.03 | \textcircled{3} | 0.01 | — | — | Glass | 60 |
| Example 6 | MgO | MgBr₂∵6H₂O | 0.03 | \textcircled{1} | 0.01 | — | — | Glass | 60 |
| Example 7 | SiO₂ | (NH₄)₂SiF₆ | 0.01 | \textcircled{2} | 0.05 | — | — | Silicon wafer | 90 |
| Example 8 | PbO₂ | Pb(ClO₄)₂∵3H₂O | 0.05 | \textcircled{2} | 0.1 | \textcircled{1} | 0.03 | Glass | 60 |
| Example 9 | TiO₂ | (OH)₂Ti(C₃H₅O₂)₂ | 0.03 | \textcircled{3} | 0.05 | — | — | Glass/TiO₂ | 90 |
| Example 10 | TiO₂ | Ti(OC₃H₇)₄ | 0.03 | \textcircled{3} | 0.1 | — | — | Glass/TiO₂ | 60 |
| Example 11 | TiO₂ | Ti(C₃H₇O)₂(C₆H₉O₃)₂ | 0.03 | \textcircled{3} | 0.05 | — | — | Glass/ZrO₂ | 80 |
| Example 12 | ZrO₂ | Zr(CH₃COCHCOCH₃)₄ | 0.03 | \textcircled{3} | 0.03 | — | — | Glass | 70 |
| Example 13 | CaO | CaCl₂∵2H₂O | 0.05 | \textcircled{4} | 0.05 | \textcircled{2} | 0.03 | Glass | 90 |
| Example 14 | TiO₂ | (C₃H₇O)₂Ti(C₅H₇O₂)₂ | 0.1 | \textcircled{3} | 0.1 | \textcircled{3} | 0.02 | Glass | 90 |
| Example 15 | In₂O₃ | In(NO₃)₃∵nH₂O | 0.01 | \textcircled{3} | 0.1 | — | — | Glass | 80 |
| Example 16 | In₂O₃ | In(NO₃)₃∵nH₂O | 0.01 | \textcircled{3} | 0.05 | — | — | Glass/TiO₂ | 50 |
| Example 17 | La₂O₃ | La(NO₃)₃∵6H₂O | 0.01 | \textcircled{4} | 0.01 | \textcircled{2} | 0.01 | Silicon wafer | 90 |
| Example 18 | CeO₂ | Ce(CH₃COO)₃∵H₂O | 0.05 | \textcircled{4} | 0.15 | — | — | Glass | 80 |
| Example 19 | ITO | In(NO₃)₃∵nH₂O | 0.01 | \textcircled{3} | 0.03 | — | — | Glass | 80 |
| | | SnCl₂ | 0.005 | | | | | | |
| Example 20 | Gd—CeO₂ | Gd(NO₃)₃ | 0.02 | \textcircled{4} | 0.05 | — | — | Glass | 90 |
| | | Ce(CH₃COO)₃∵H₂O | 0.005 | | | | | | |
| Example 21 | Sm—CeO₂ | Sm(NO₃)₃ | 0.02 | \textcircled{2} | 0.05 | — | — | Glass | 80 |
| | | Ce(CH₃COO)₃∵H₂O | 0.005 | | | | | | |

| | | | | | Thermal | | |
|---|---|---|---|---|---|---|---|
| | | | | Film | treatment | | |
| | | | UV | thickness | after film | XRD | |
| | Time | Bubbling | (mW/cm²) | (nm) | formation | crystallinity | ESCA |
| Example 4 | 12 h | Air | 20 | 200 | — | ο | ο |
| Example 5 | 1 h | — | 20 | 100 | — | ο | ο |
| Example 6 | 24 h | — | — | 120 | 100° C. 5 h | X | ο |
| Example 7 | 1 h | — | — | 200 | — | X | ο |
| Example 8 | 1 h | — | — | 150 | 150° C. 1 h | ο | ο |
| Example 9 | 5 h | — | — | 150 | — | ο | ο |
| Example 10 | 12 h | — | — | 200 | — | ο | ο |
| Example 11 | 5 h | — | — | 120 | — | ο | ο |
| Example 12 | 24 h | — | — | 100 | — | ο | ο |
| Example 13 | 30 min | Air | — | 80 | — | X | ο |
| Example 14 | 2 h | Air | — | 300 | — | ο | ο |
| Example 15 | 50 min | Air | — | 150 | 150° C. 1 h | ο | ο |
| Example 16 | 3 min | Air | — | 5 | — | ο | ο |
| Example 17 | 1 h | Air | — | 120 | 400° C. 1 h | ο | ο |
| Example 18 | 1 h | Air | — | 380 | — | ο | ο |
| Example 19 | 1 h | Air | — | 150 | — | ο | ο |
| Example 20 | 1 h | Air | — | 80 | — | ο | ο |
| Example 21 | 6 h | Air | — | 120 | — | ο | ο |

| | |
|---|---|
| Reducing | Boron-tert-butylamine complex |
| agent \textcircled{1} | |
| \textcircled{2} | Boron-N,N-diethylaniline |
| | complex |
| \textcircled{3} | Boron-dimethylamine complex |
| \textcircled{4} | Boron-triethylamine complex |
| Auxiliary ion | Chlorate ion |
| source \textcircled{1} | |
| \textcircled{2} | Bromate ion |
| \textcircled{3} | Hypobromate ion |
| \textcircled{4} | Perchlorate ion |
| Auxiliary ion | Chlorite ion |
| soruce \textcircled{5} | |
| \textcircled{6} | Hypochlorite ion |
| \textcircled{7} | Nitrate ion |
| \textcircled{8} | Nitrite ion |

TABLE 2

| | | | | Reducing | | Auxiliary | | | Liquid |
|---|---|---|---|---|---|---|---|---|---|
| | Metal | | | agent | | ion source | | | temperature |
| | oxide film | Metal Source (mol/l) | | (mol/l) | | (mol/l) | | Substrate | (° C.) |
| Example 22 | Al₂O₃ | AlCl₃ | 0.08 | \textcircled{2} | 0.1 | \textcircled{4} | 0.01 | Silicon | 65 |
| | | | | | | | | wafer | |
| Example 23 | V₂O₅ | VCl₂ | 0.02 | \textcircled{3} | 0.05 | \textcircled{7} | 0.02 | Glass | 80 |
| Example 24 | MnO₂ | Mn(CH₃COO)₂∵4H₂O | 0.03 | \textcircled{2} | 0.03 | \textcircled{8} | 0.02 | Titanium | 50 |
| | | | | | | | | plate | |
| Example 25 | Fe₂O₃ | Fe(ClO₄)₃∵6H₂O | 0.01 | \textcircled{3} | 0.01 | — | — | Silicon | 50 |
| | | | | | | | | wafer | |
| Example 26 | Co₃O₄ | Co(NO₃)₂∵6H₂O | 0.03 | \textcircled{1} | 0.03 | — | — | — | 80 |
| Example 27 | NiO | Ni(CH₃COO)₂∵4H₂O | 0.01 | \textcircled{2} | 0.02 | \textcircled{2} | 0.03 | Glass/TiO₂ | 50 |
| Example 28 | CuO | Cu(NO₃)₂∵3H₂O | 0.01 | \textcircled{4} | 0.02 | \textcircled{4} | 0.01 | Glass/TiO₂ | 50 |
| Example 29 | ZnO | ZnCl₂ | 0.02 | \textcircled{2} | 0.02 | \textcircled{5} | 0.03 | Glass/TiO₂ | 70 |
| Example 30 | Y₂O₃ | Y(CH₃COO)₃∵4H₂O | 0.05 | \textcircled{4} | 0.08 | — | — | Glass/TiO₂ | 80 |
| Example 31 | AgO | AgNO₃ | 0.01 | \textcircled{1} | 0.05 | \textcircled{8} | 0.02 | Glass | 90 |
| Example 32 | Sm₂O₃ | Sm(NO₃)₃∵6H₂O | 0.06 | \textcircled{3} | 0.07 | \textcircled{6} | 0.05 | Glass/TiO₂ | 60 |
| Example 33 | Ga dope | La(NO₃)₃∵6H₂O | 0.02 | \textcircled{3} | 0.03 | — | — | Silicon | 70 |
| | La₂O₃ | Ga(NO₃)₃ | 0.005 | | | | | wafer | |
| Example 34 | HfO₂ | Hf(SO₄)₂ | 0.07 | \textcircled{1} | 0.1 | \textcircled{4} | 0.05 | SUS | 60 |
| Example 35 | Sc₂O₃ | Sc(NO₃)₃∵4H₂O | 0.07 | \textcircled{1} | 0.1 | — | — | Glass/TiO₂ | 50 |
| Example 36 | Gd₂O₃ | Gd(NO₃)₃∵6H₂O | 0.05 | \textcircled{4} | 0.1 | — | — | Glass/TiO₂ | 90 |
| Example 37 | NiO—YSZ | Ni(CH₃COO)₂∵4H₂O | 0.03 | \textcircled{3} | 0.05 | — | — | Silicon | 60 |
| | | ZrO(NO₃)₂∵2H₂O | 0.03 | | | | | wafer | |
| | | YCl₃∵6H₂O | 0.01 | | | | | | |

| | | | | | Thermal | | |
|---|---|---|---|---|---|---|---|
| | | | | Film | treatment | | |
| | | | UV | thickness | after film | XRD | |
| | Time | Bubbling | (mW/cm²) | (nm) | formation | crystallinity | ESCA |
| Example 22 | 24 h | Air | — | 60 | 1000° C. 1 h | ο | ο |
| Example 23 | 12 h | — | — | 150 | 500° C. 1 h | ο | ο |
| Example 24 | 8 h | — | — | 300 | 100° C. 1 h | ο | ο |
| Example 25 | 10 h | — | 20 | 400 | — | ο | ο |
| Example 26 | 24 h | — | — | 300 | 500° C. 1 h | ο | ο |
| Example 27 | 12 h | — | 10 | 200 | 200° C. 1 h | ο | ο |
| Example 28 | 5 h | — | — | 100 | 400° C. 1 h | ο | ο |
| Example 29 | 2 h | — | — | 100 | 500° C. 1 h | ο | ο |
| Example 30 | 6 h | — | 20 | 200 | 300° C. 1 h | ο | ο |
| Example 31 | 24 h | — | — | 50 | 500° C. 1 h | X | ο |
| Example 32 | 10 h | Air | — | 40 | 500° C. 1 h | X | ο |
| Example 33 | 24 h | — | — | 80 | 500° C. 1 h | ο | ο |
| Example 34 | 24 h | — | 10 | 80 | 400° C. 1 h | ο | ο |
| Example 35 | 24 h | Air | — | 40 | 500° C. 1 h | X | ο |
| Example 36 | 10 h | Air | — | 40 | 500° C. 1 h | X | ο |
| Example 37 | 24 h | — | — | 200 | 1000° C. 1 h | ο | ο |

| | |
|---|---|
| Reducing | Boron-tert-butylamine complex |
| agent \textcircled{1} | |
| \textcircled{2} | Boron-N,N-diethylaniline |
| | complex |
| \textcircled{3} | Boron-dimethylamine complex |
| \textcircled{4} | Boron-triethylamine complex |
| Auxiliary ion | Chlorate ion |
| source \textcircled{1} | |
| \textcircled{2} | Bromate ion |
| \textcircled{3} | Hypobromate ion |
| \textcircled{4} | Perchlorate ion |
| Auxiliary ion | Chlorite ion |
| source \textcircled{5} | |
| \textcircled{6} | Hypochlorite ion |
| \textcircled{7} | Nitrate ion |
| \textcircled{8} | Nitrite ion |

### BRIEF DESCRIPTION OF THE DRAWINGS

FIGS. 1A to 1F is an explanatory view illustrating an example of a film forming reaction in the method of the invention for producing a metal oxide film.

FIG. 2 is a relationship view (Pourbaix diagram) showing a relationship between pH and electric potential for cerium.

FIG. 3 is an explanatory view illustrating an example of the method of the invention for producing a metal oxide film.

FIGS. 4A and 4B are each an explanatory view illustrating another example of the method of the invention for producing a metal oxide film.

FIG. 5 is an explanatory view illustrating yet another example of the method of the invention for producing a metal oxide film.

FIG. 6 is an explanatory view illustrating still another example of the method of the invention for producing a metal oxide film.

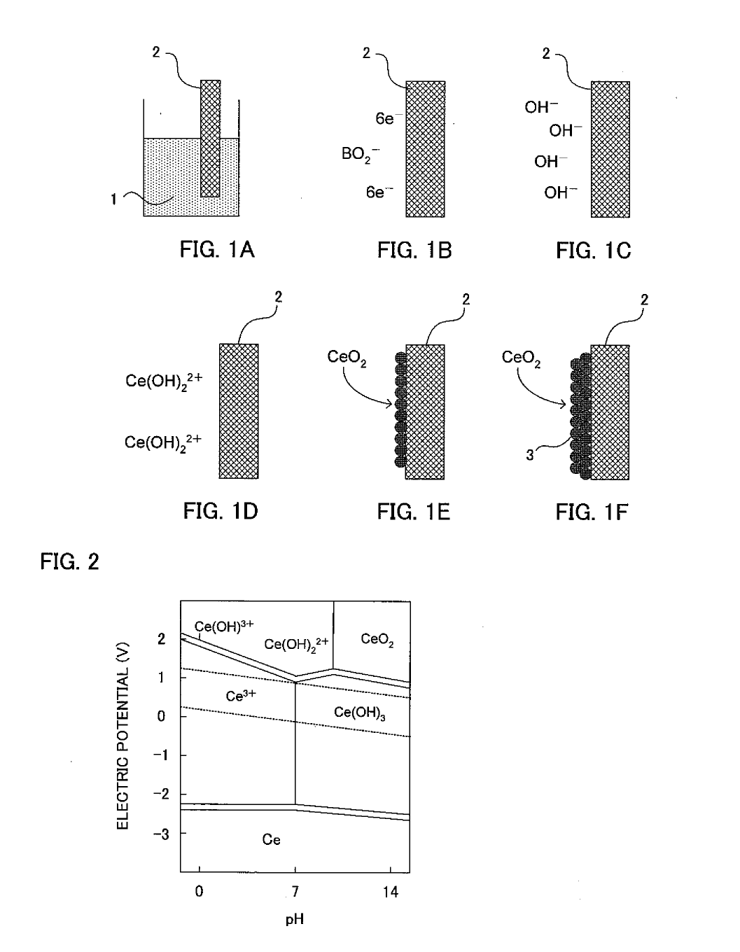

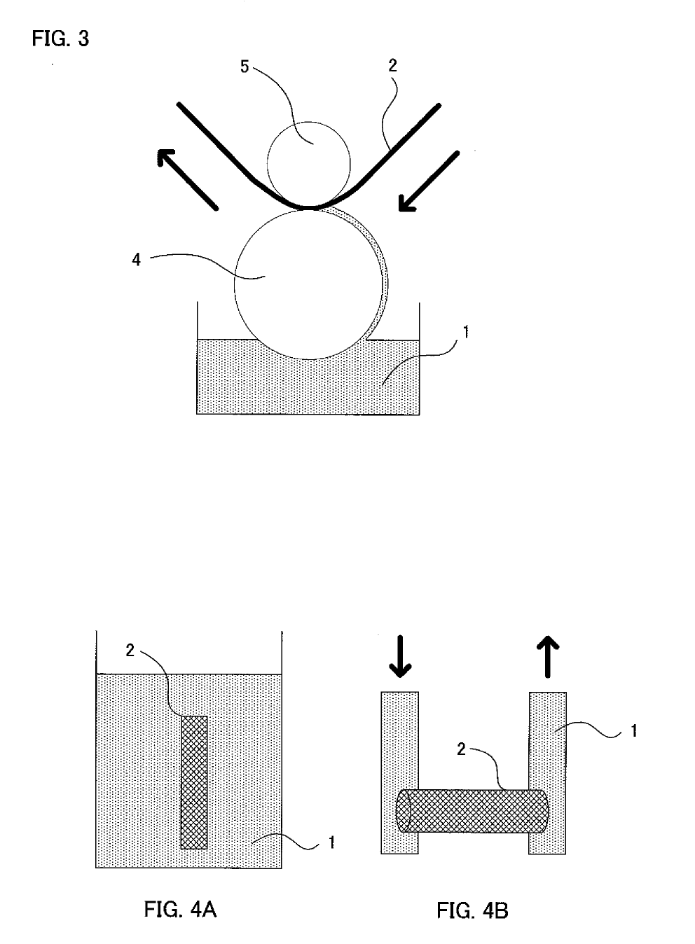

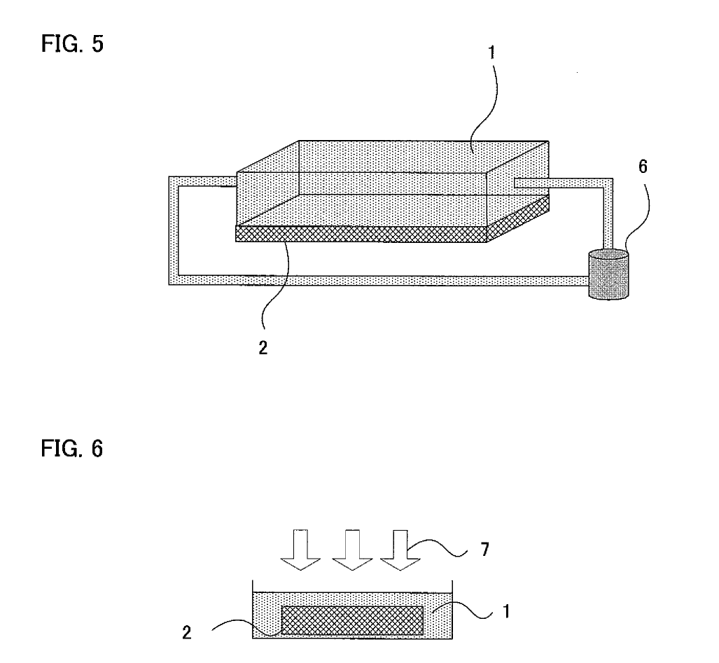

### EXPLANATION OF REFERENCE NUMERALS

1: metal oxide film-forming solution
2: substrate
3: cerium oxide film
4 and 5: rollers
6: pump
7: ultraviolet rays

1. A method of producing a metal oxide film, wherein a metal oxide film is obtained by bringing a surface of a substrate into contact with a metal oxide film-forming solution that has a metal salt or a metal complex dissolved as a metal source, and
wherein the metal oxide film-forming solution comprises a reducing agent.

2. The method of producing a metal oxide film according to claim 1, wherein an oxidized gas is mixed at the time of bringing the metal oxide film-forming solution into contact with the surface of the substrate.

3. The method of producing a metal oxide film according to claim 2, wherein the oxidized gas is oxygen or ozone.

4. The method of producing a metal oxide film according to claim 1, wherein ultraviolet rays are irradiated at the time of bringing the metal oxide film-forming solution into contact with the surface of the substrate.

5. The method of producing a metal oxide film according to claim 1, wherein the metal source used in the metal oxide film-forming solution comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta.

6. The method of producing a metal oxide film according to claim 2, wherein the metal source used in the metal oxide film-forming solution comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta.

7. The method of producing a metal oxide film according to claim 3, wherein the metal source used in the metal oxide film-forming solution comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta.

8. The method of producing a metal oxide film according to claim 4, wherein the metal source used in the metal oxide film-forming solution comprises at least one metal element selected from the group consisting of Mg, Al, Si, Ca, Ti, V, Mn, Fe, Co, Ni, Cu, Zn, Y, Zr, Ag, In, Sn, Ce, Sm, Pb, La, Hf, Sc, Gd, and Ta.

9. The method of producing a metal oxide film according to claim 1, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

10. The method of producing a metal oxide film according to claim 2, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

11. The method of producing a metal oxide film according to claim 3, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

12. The method of producing a metal oxide film according to claim 4, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

13. The method of producing a metal oxide film according to claim 5, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

14. The method of producing a metal oxide film according to claim 6, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

15. The method of producing a metal oxide film according to claim 7, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.

16. The method of producing a metal oxide film according to claim 8, wherein the metal oxide film-forming solution comprises at least one ion species selected from the group consisting of a chlorate ion, a perchlorate ion, a chlorite ion, a hypochlorite ion, a bromate ion, a hypobromate ion, a nitrate ion, and a nitrite ion.
